(19) United States
(12) Patent Application Publication
(10) Pub. No.: US 2023/0311059 A1
(43) Pub. Date: Oct. 5, 2023

(54) DEVICE AND METHOD FOR TREATING WASTE GAS THROUGH VARIABLE-DIAMETER ACCELERATION-BASED FREE RADICAL SHOWER IN COMBINATION WITH CATALYSIS

(71) Applicant: Jiangsu University, Jiangsu (CN)

(72) Inventors: Lu LIU, Jiangsu (CN); Peng GONG, Jiangsu (CN); Junfeng WANG, Jiangsu (CN); Guangcai SHAO, Jiangsu (CN); Shuang WANG, Jiangsu (CN)

(73) Assignee: Jiangsu University, Jiangsu (CN)

(21) Appl. No.: 18/012,986

(22) PCT Filed: Jan. 27, 2022
(86) PCT No.: PCT/CN2022/074189

§ 371 Date: Dec. 27, 2022

(30) Foreign Application Priority Data
Oct. 29, 2021 (CN) 202111270887.2

(51) Int. Cl. B01D 53/32; B01D 53/86

(52) U.S. Cl. CPC B01D 53/32; B01D 53/8687; B01D 2259/818

(57) ABSTRACT

The invention provides a method for monitoring health state of blade root fastener, comprising the following steps: obtaining a sequence of acceleration signals representing the lateral vibration of the nacelle and a sequence of rotational speed signals representing the rotational speed of the rotor; analyzing the sequence of acceleration signals and the sequence of rotational speed signals to determine the amplitude of the nacelle at 2-time-frequncy of the rotational speed of the rotor; and determining the health state of the blade root fastener based on the amplitude. The invention also provides a system for monitoring the health state of the blade root fastener. Through the present invention, the health state of the blade root fastener can be determined with low cost and high precision, thereby improving the operation efficiency and operation safety of the wind turbine.

### BACKGROUND

### Technical Field

The present disclosure relates to the field of organic waste gas control, and particularly to a device for treating waste gas through variable-diameter acceleration-based free radical shower in combination with catalysis and a working method using the same.

### Related Art

Organic waste gas is one of the main factors leading to the deterioration of the atmospheric environment, and is also an important precursor for the formation of fine particulate matters (PM2.5), ozone, and photochemical smog. In the technologies for degrading organic waste gas through the combination of non-thermal plasma with catalysis, organics are decomposed into small molecules or free radicals by the plasma, and further decomposed into carbon dioxide and water under the action of the catalysis, which reduces the activation energy and improves the degradation efficiency. Corona discharge free radical shower is a plasma generation technology, which uses an electrode of a nozzle structure to efficiently decompose the electrode gas to generate plasma rich in free radicals. The corona discharge free radical shower has a low initial voltage, a low energy consumption, and a high energy utilization rate. Compared with ordinary plasma generating devices, the free radical shower needs the additional electrode gas to flow through the nozzle electrode to generate plasma. Moreover, due to the need for the electrode gas, the electrode structure for the free radical shower is complicated. These problems limit the application of the free radical shower in waste gas treatment devices.

### SUMMARY OF INVENTION

To solve the problem that the free radical shower requires the additional electrode gas and a complicated electrode structure, the present disclosure provides a device for treating waste gas through variable-diameter acceleration-based free radical shower in combination with catalysis. The present disclosure divides the organic waste gas to provide the electrode gas through variable-diameter acceleration, thereby simplifying the structure and reducing the operating costs.

The above technical object of the present disclosure is attained with the following technical means.

A device for treating waste gas through variable-diameter acceleration-based free radical shower in combination with catalysis is provided, including a waste gas inlet, a background waste gas channel, an electrode waste gas channel, a variable-diameter acceleration channel, a nozzle electrode, and a mesh electrode. An output end of the waste gas inlet is communicated with the background waste gas channel and the electrode waste gas channel. A part of the waste gas enters the electrode waste gas channel and then enters the variable-diameter acceleration channel, and the remainder of the waste gas enters the background waste gas channel. The variable-diameter acceleration channel is a tapered variable-diameter pipe. The variable-diameter acceleration channel is supported by an electrode insulating layer. An input end of the variable-diameter acceleration channel is the electrode waste gas channel, and an output end of the variable-diameter acceleration channel is the nozzle electrode. The mesh electrode is arranged above the nozzle electrode. A catalyst layer is arranged on the mesh electrode. A high voltage difference is formed between the mesh electrode and the nozzle electrode.

Further, a plurality of electrode insulating layers are arranged, the electrode insulating layers are distributed up and down, and the variable-diameter acceleration channel is arranged on each of the plurality of the electrode insulating layers; and a plurality of layers of mesh electrodes are arranged, and the mesh electrodes are respectively arranged above each layer of nozzle electrodes.

Further, an input end of the electrode waste gas channel is an electrode waste gas inlet, and a ratio of a hole diameter of the electrode waste gas inlet to a hole diameter of the nozzle electrode is 1.5-5.

Further, an input end of the electrode waste gas channel is an electrode waste gas inlet, and a ratio of a hole diameter of the electrode waste gas inlet to a hole diameter of the nozzle electrode is 2-2.5.

Further, the mesh electrode is connected to a high-voltage power supply through a mesh electrode lead, and the nozzle electrode is connected to a grounding device through a nozzle electrode lead.

Further, a heating device is arranged in the waste gas inlet or in the catalyst layer.

Further, a gas distribution plate with holes is arranged upstream of an input end of the background waste gas channel and an input end of the electrode waste gas channel.

Further, the waste gas treated is discharged through a housing via a waste gas outlet.

Further, the nozzle electrode, the mesh electrode, and the catalyst layer are arranged in a housing, and a housing insulating layer is arranged outside the housing.

A treatment method using the device for treating the waste gas through the variable-diameter acceleration-based free radical shower in combination with the catalysis is provided, including the following steps: allowing an organic waste gas to enter the background waste gas channel and the electrode waste gas channel through the waste gas inlet; allowing the organic waste gas in the electrode waste gas channel to be accelerated through the variable-diameter acceleration channel and reach the nozzle electrode; and forming a free radical shower discharge by a potential difference between the nozzle electrode and the mesh electrode, so that the waste gas ejected from the nozzle electrode is ionized to form a plasma cluster which is mixed with a background gas from the background waste gas channel to form a mixed gas flow, driving the mixed gas flow to enter the catalyst layer by a gas flow to allow the organic waste gas to be oxidized and reduced under a joint action of the plasma cluster and a catalyst in the catalyst layer, and discharging the waste gas with removed organics through a waste gas outlet.

### Beneficial Effects

1. In the present disclosure, the organic waste gas is divided into parts which enter the background waste gas channel and the electrode waste gas channel respectively. The part of the waste gas entering the electrode waste gas channel is accelerated and discharged and then ionized to form a plasma cluster, which is mixed with the background gas from the background waste gas channel, and the mixed gas flow is driven by the gas flow to enter the catalyst layer to allow the organic waste gas to be oxidized and reduced under the joint action of the plasma cluster and the catalyst in the catalyst layer to obtain the waste gas with removed organics.

2. Because the organic waste gas entering the electrode waste gas channel is accelerated by the variable-diameter acceleration channel, the flow rate of the electrode gas is higher than that of the background gas. On the one hand, more gas flows through the nozzle electrode, so that more gas is ionized and more free radicals are generated. On the other hand, the mixing of the plasma flow and the background gas is enhanced to make the reaction more complete.

3. The purpose of arranging the gas distribution plate at the waste gas inlet and the waste gas outlet is to make the waste gas evenly enter the background waste gas channel and the electrode waste gas channel.

4. When the gas is at room temperature or low temperature, the heating device is additionally provided outside the catalyst layer or at the waste gas inlet. The heating device can be operated with the treatment device for a long time to keep the catalyst layer or the waste gas at a certain temperature (50° C.-200° C.). The heating device may also be operated intermittently to provide a certain amount of heat to the catalyst layer or the waste gas when necessary, so as to desorb water and organics adsorbed on the catalyst to maintain the catalytic effect.

5. The present disclosure may be of a one-stage or multi-stage configuration, and the multi-stage configuration can achieve a more thorough treatment of the organic waste gas.

6. The treatment device of the present disclosure does not need to provide the additional electrode gas for the free radical shower, which reduces the costs and maximizes the utilization and degradation of waste gas.

### BRIEF DESCRIPTION OF DRAWINGS

FIG. 1 is a schematic structural diagram of a two-stage device for treating waste gas through variable-diameter acceleration-based free radical shower in combination with catalysis according to Embodiment 1 of the present disclosure.

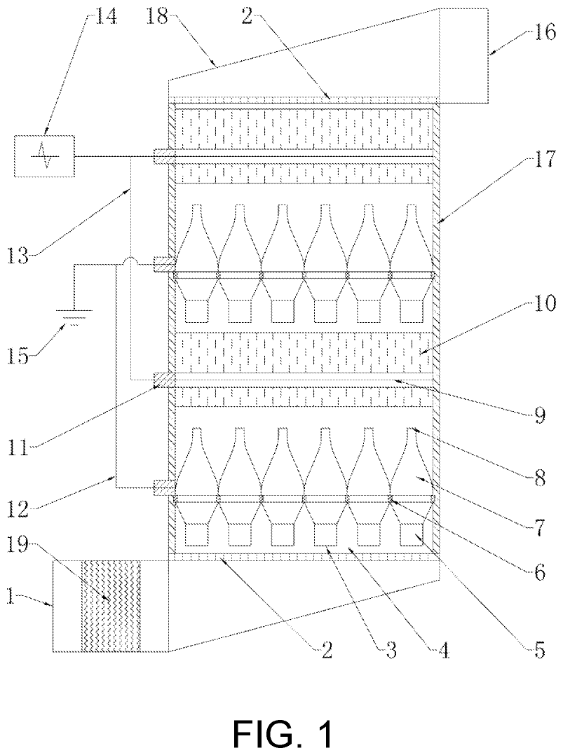

FIG. 2 is a cross-sectional view of FIG. 1 along line A-A.

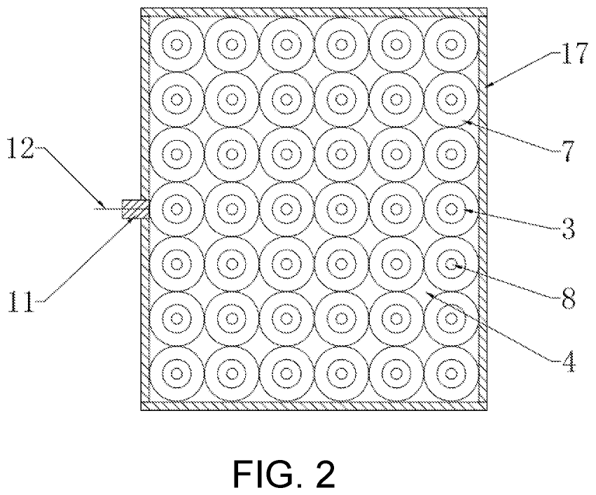

FIG. 3 is a schematic structural diagram of a device for treating waste gas through variable-diameter acceleration-based free radical shower in combination with catalysis according to Embodiment 2 of the present disclosure.

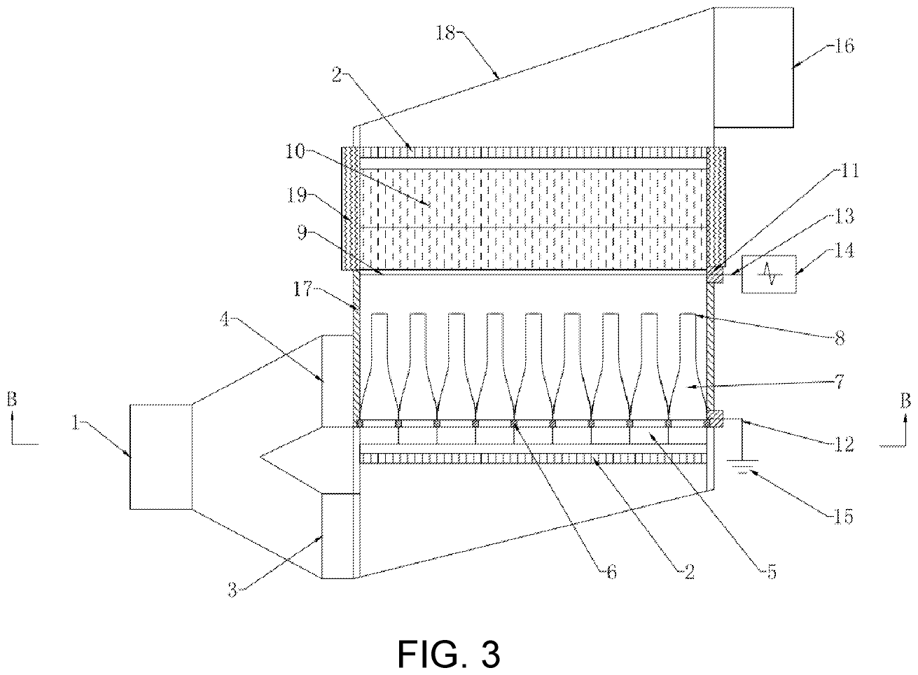

FIG. 4 is a cross-sectional view of FIG. 3 along line B-B.

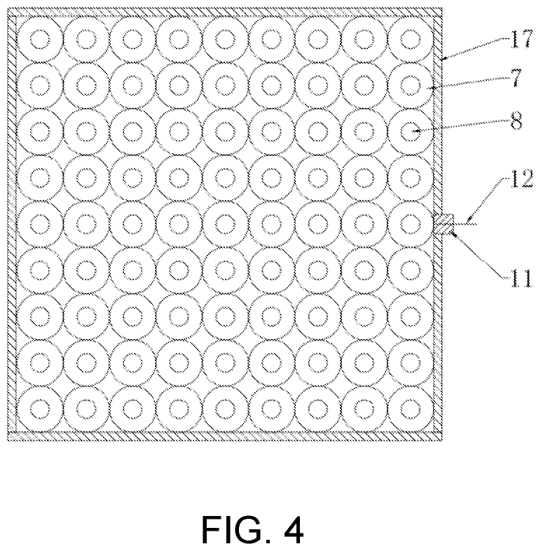

### DESCRIPTION OF EMBODIMENTS

Embodiments of the present disclosure will be exemplarily described in detail hereinafter with reference to accompanying drawings in which the same or like reference characters refer to the same or like elements or elements having the same or like functions throughout. The embodiments described below with reference to accompanying drawings are exemplary, and intended to explain, instead of limiting the present disclosure.

In the description of the present disclosure, it should be understood that the orientation or positional relationships indicated by the terms “center”, “longitudinal”, “transverse”, “length”, “width”, “thickness”, “upper”, “lower”, “axial”, “radial”, “vertical”, “horizontal”, “inner”, “outer”, etc. are based on the orientation or positional relationships shown in the drawings, and are only for the convenience of describing the present disclosure and simplifying the description, rather than indicating or implying that the apparatus or element described must have a specific orientation or be constructed and operated in a specific orientation, and therefore are not to be construed as limiting the present disclosure. Moreover, the terms “first” and “second” are used herein for purposes of description, and are not intended to indicate or imply relative importance or implicitly point out the number of the indicated technical feature. Therefore, the features defined by “first” and “second” may explicitly or implicitly include one or more features. In the description of the present disclosure, “plural” means two or more, unless it is defined otherwise specifically.

In the present disclosure, unless otherwise clearly specified and defined, the terms “mount”, “connect”, “couple”, “fix” and variants thereof should be interpreted in a broad sense, for example, may be a fixed connection, a detachable connection, or an integral connection; may be a mechanical connection or an electrical connection; or may be a direct connection, an indirectly connection via an intermediate medium, or communication between the interiors of two components. For those of ordinary skill in the art, the specific meanings of the above terms in the present disclosure can be understood according to specific circumstances.

A device for treating waste gas through variable-diameter acceleration-based free radical shower in combination with catalysis includes a waste gas inlet 1, a gas distribution plate 2, an electrode waste gas inlet 3, a background waste gas channel 4, an electrode waste gas channel 5, an electrode insulating layer 6, a variable-diameter acceleration channel 7, a nozzle electrode 8, a mesh electrode 9, a catalyst layer 10, a lead insulating layer 11, a nozzle electrode lead 12, a mesh electrode lead 13, a high-voltage power supply 14, a grounding device 15, a waste gas outlet 16, a housing insulating layer 17, a housing 18, and a heating device 19.

The specific process is as follows.

Organic waste gas is allowed to enter the treatment device through the waste gas inlet 1, and enter the electrode waste gas inlet 3 and the background waste gas channel 4 separately through the gas distribution plate 2. The organic waste gas entering the electrode waste gas inlet 3 is accelerated through the variable-diameter acceleration channel 7 and reaches the nozzle electrode 8. One of the nozzle electrodes 8 and the mesh electrode 10 is connected to the high-voltage power supply through a lead, and the other is grounded, forming a very high potential difference therebetween, and thus forming a free radical shower discharge. The organic waste gas is ejected through the nozzle electrode, and ionized to form a plasma cluster, which is mixed with background gas from the background waste gas channel 4 to form a mixed gas flow. The mixed gas flow is driven to enter the catalyst layer 10 by the gas flow, to allow the organic waste gas to be oxidized into carbon dioxide and water under the joint action of the plasma cluster and a catalyst in the catalyst layer 10. Clean waste gas is discharged through the waste gas outlet.

In particular, the nozzle electrode lead 12 and the mesh electrode lead 13 are each wrapped by a lead insulating layer, and the housing insulating layer 17 is arranged between the nozzle electrode 8 and the housing 18 and between the mesh electrode 9 and the housing 18.

In particular, when the gas is at room temperature or low temperature, the heating device is additionally provided outside the catalyst layer or at the waste gas inlet. The heating device can be operated with the treatment device for a long time to keep the catalyst layer or the waste gas at a certain temperature (50° C.-200° C.). The heating device may also be operated intermittently to provide a certain amount of heat to the catalyst layer or the waste gas when necessary, so as to desorb water and organics adsorbed on the catalyst to maintain the catalytic effect.

In particular, a ratio of a diameter of the electrode waste gas inlet to a diameter of the nozzle electrode is about 1.5-5. In this case, a ratio of a gas flow rate at the electrode waste gas inlet to a gas flow rate at an outlet of the nozzle electrode is about 2.2-25. Generally, when the ratio of the diameter of the electrode waste gas inlet to the diameter of the nozzle electrode is about 2-2.5, and the ratio of the gas flow rate at the electrode waste gas inlet to the gas flow rate at the outlet of the nozzle electrode is about 4-6, an optimal removal effect is achieved.

The function of the electrode insulating layer 6 is to support the variable-diameter acceleration channel, and also to prevent the background gas from being charged.

### Embodiment 1

A two-stage device for treating waste gas through variable-diameter acceleration-based free radical shower in combination with catalysis is provided, where the diameter of the electrode waste gas inlet 5 is 3 cm, and the diameter of the nozzle electrode 8 is 1 cm. The electrode waste gas channel 5, the variable-diameter acceleration channel 7, the electrode insulating layer 6, and the nozzle electrode 8 form a high-flow-rate gas channel. The space between the housing 18 and the high-flow-rate gas channel is a low-flow-rate gas channel.

A flow rate at an inlet of the high-flow-rate gas channel is the same as a flow rate at an inlet of the low-flow-rate gas channel. Due to the difference between the cross-sectional areas of the high-flow-rate gas channel and the low-flow-rate gas channel, a flow rate at an outlet of the high-flow-rate gas channel is 8-10 times a flow rate at an outlet of the low-flow-rate gas channel. The waste gas at the outlet of the low-flow-rate gas channel is used as the background gas. The waste gas at the outlet of the high-flow-rate gas channel is used as the electrode gas. A free radical shower plasma is formed under the action of a high voltage.

For the nozzle electrode 8 and the mesh electrode 9, the mesh electrode 9 is connected to the high-voltage power supply 14, and the nozzle electrode 8 is grounded. A very high potential difference is formed between the mesh electrode 9 and the nozzle electrode 8, thus forming a corona free radical shower discharge. The organic waste gas is ejected through the nozzle electrode 8, and ionized to form a plasma cluster, which is mixed with the background gas to obtain a mixed gas flow. The mixed gas flow is driven to enter the catalyst layer by the gas flow to allow the organic waste gas to be oxidized into carbon dioxide and water under the joint action of the plasma cluster and the catalyst in the catalyst layer.

### Embodiment 2

Different from Example 1, the electrode waste gas inlet 3 is separated from the background waste gas inlet 3, the organic waste gas is first divided into two parts and then the two parts enter the electrode waste gas inlet 3 and the background waste gas inlet 4 respectively, and the background gas flows in from the side.

In the description of the specification, the description with reference to the terms “an embodiment”, “some embodiments”, “example”, “specific example”, or “some example” and so on means that specific features, structures, materials or characteristics described in connection with the embodiment or example are embraced in at least one embodiment or example of the present disclosure. In the present specification, the illustrative expression of the above terms is not necessarily referring to the same embodiment or example. Moreover, the described specific features, structures, materials or characteristics may be combined in any suitable manner in one or more embodiments.

Although the embodiments of the present disclosure have been illustrated and described above, it is to be understood that the above embodiments are exemplary and not to be construed as limiting the present disclosure, and that changes, modifications, substitutions and alterations can be made by those skilled in the art without departing from the scope of the present disclosure.

1. A device for treating waste gas through variable-diameter acceleration-based free radical shower in combination with catalysis, comprising a waste gas inlet, a background waste gas channel, an electrode waste gas channel, a variable-diameter acceleration channel, a nozzle electrode, and a mesh electrode, wherein
an output end of the waste gas inlet is communicated with the background waste gas channel and the electrode waste gas channel, a part of the waste gas enters the electrode waste gas channel and then enters the variable-diameter acceleration channel, and the remainder of the waste gas enters the background waste gas channel; the variable-diameter acceleration channel is a tapered variable-diameter pipe; the variable-diameter acceleration channel is supported by an electrode insulating layer; an input end of the variable-diameter acceleration channel is the electrode waste gas channel, and an output end of the variable-diameter acceleration channel is the nozzle electrode; the mesh electrode is arranged above the nozzle electrode; a catalyst layer is arranged on the mesh electrode; and a high voltage difference is formed between the mesh electrode and the nozzle electrode.

2. The device for treating the waste gas through the variable-diameter acceleration-based free radical shower in combination with the catalysis according to claim 1, wherein, a plurality of electrode insulating layers are arranged, the electrode insulating layers are distributed up and down, and the variable-diameter acceleration channel is arranged on each of the plurality of the electrode insulating layers; and a plurality of layers of mesh electrodes are arranged, and the mesh electrodes are respectively arranged above each layer of the nozzle electrodes.

3. The device for treating the waste gas through the variable-diameter acceleration-based free radical shower in combination with the catalysis according to claim 1, wherein, an input end of the electrode waste gas channel is an electrode waste gas inlet, and a ratio of a hole diameter of the electrode waste gas inlet to a hole diameter of the nozzle electrode is 1.5-5.

4. The device for treating the waste gas through the variable-diameter acceleration-based free radical shower in combination with the catalysis according to claim 1, wherein, an input end of the electrode waste gas channel is an electrode waste gas inlet, and a ratio of a hole diameter of the electrode waste gas inlet to a hole diameter of the nozzle electrode is 2-2.5.

5. The device for treating the waste gas through the variable-diameter acceleration-based free radical shower in combination with the catalysis according to claim 1, wherein, the mesh electrode is connected to a high-voltage power supply through a mesh electrode lead, and the nozzle electrode is connected to a grounding device through a nozzle electrode lead.

6. The device for treating the waste gas through the variable-diameter acceleration-based free radical shower in combination with the catalysis according to claim 1, wherein, a heating device is arranged in the waste gas inlet or in the catalyst layer.

7. The device for treating the waste gas through the variable-diameter acceleration-based free radical shower in combination with the catalysis according to claim 1, wherein, a gas distribution plate with holes is arranged upstream of an input end of the background waste gas channel and an input end of the electrode waste gas channel.

8. The device for treating the waste gas through the variable-diameter acceleration-based free radical shower in combination with the catalysis according to claim 1, wherein, the waste gas treated is discharged through a housing via a waste gas outlet.

9. The device for treating the waste gas through the variable-diameter acceleration-based free radical shower in combination with the catalysis according to claim 1, wherein, the nozzle electrode, the mesh electrode, and the catalyst layer are arranged in a housing, and a housing insulating layer is arranged outside the housing.

10. A treatment method using the device for treating the waste gas through the variable-diameter acceleration-based free radical shower in combination with the catalysis according to claim 1, comprising the following steps:
allowing an organic waste gas to enter the background waste gas channel and the electrode waste gas channel through the waste gas inlet;
allowing the organic waste gas in the electrode waste gas channel to be accelerated through the variable-diameter acceleration channel and reach the nozzle electrode; and
forming a free radical shower discharge by a potential difference between the nozzle electrode and the mesh electrode, so that the waste gas ejected from the nozzle electrode is ionized to form a plasma cluster which is mixed with a background gas from the background waste gas channel to form a mixed gas flow, and driving the mixed gas flow to enter the catalyst layer by a gas flow to allow the organic waste gas to be oxidized and reduced under a joint action of the plasma cluster and a catalyst in the catalyst layer, and discharging the waste gas with removed organics through a waste gas outlet.

11. A treatment method using the device for treating the waste gas through the variable-diameter acceleration-based free radical shower in combination with the catalysis according to claim 2, comprising the following steps:
allowing an organic waste gas to enter the background waste gas channel and the electrode waste gas channel through the waste gas inlet;
allowing the organic waste gas in the electrode waste gas channel to be accelerated through the variable-diameter acceleration channel and reach the nozzle electrode; and
forming a free radical shower discharge by a potential difference between the nozzle electrode and the mesh electrode, so that the waste gas ejected from the nozzle electrode is ionized to form a plasma cluster which is mixed with a background gas from the background waste gas channel to form a mixed gas flow, and driving the mixed gas flow to enter the catalyst layer by a gas flow to allow the organic waste gas to be oxidized and reduced under a joint action of the plasma cluster and a catalyst in the catalyst layer, and discharging the waste gas with removed organics through a waste gas outlet.

12. A treatment method using the device for treating the waste gas through the variable-diameter acceleration-based free radical shower in combination with the catalysis according to claim 3, comprising the following steps:
allowing an organic waste gas to enter the background waste gas channel and the electrode waste gas channel through the waste gas inlet;
allowing the organic waste gas in the electrode waste gas channel to be accelerated through the variable-diameter acceleration channel and reach the nozzle electrode; and
forming a free radical shower discharge by a potential difference between the nozzle electrode and the mesh electrode, so that the waste gas ejected from the nozzle electrode is ionized to form a plasma cluster which is mixed with a background gas from the background waste gas channel to form a mixed gas flow, and driving the mixed gas flow to enter the catalyst layer by a gas flow to allow the organic waste gas to be oxidized and reduced under a joint action of the plasma cluster and a catalyst in the catalyst layer, and discharging the waste gas with removed organics through a waste gas outlet.

13. A treatment method using the device for treating the waste gas through the variable-diameter acceleration-based free radical shower in combination with the catalysis according to claim 4, comprising the following steps:
allowing an organic waste gas to enter the background waste gas channel and the electrode waste gas channel through the waste gas inlet;
allowing the organic waste gas in the electrode waste gas channel to be accelerated through the variable-diameter acceleration channel and reach the nozzle electrode; and
forming a free radical shower discharge by a potential difference between the nozzle electrode and the mesh electrode, so that the waste gas ejected from the nozzle electrode is ionized to form a plasma cluster which is mixed with a background gas from the background waste gas channel to form a mixed gas flow, and driving the mixed gas flow to enter the catalyst layer by a gas flow to allow the organic waste gas to be oxidized and reduced under a joint action of the plasma cluster and a catalyst in the catalyst layer, and discharging the waste gas with removed organics through a waste gas outlet.

14. A treatment method using the device for treating the waste gas through the variable-diameter acceleration-based free radical shower in combination with the catalysis according to claim 5, comprising the following steps:
allowing an organic waste gas to enter the background waste gas channel and the electrode waste gas channel through the waste gas inlet;
allowing the organic waste gas in the electrode waste gas channel to be accelerated through the variable-diameter acceleration channel and reach the nozzle electrode; and
forming a free radical shower discharge by a potential difference between the nozzle electrode and the mesh electrode, so that the waste gas ejected from the nozzle electrode is ionized to form a plasma cluster which is mixed with a background gas from the background waste gas channel to form a mixed gas flow, and driving the mixed gas flow to enter the catalyst layer by a gas flow to allow the organic waste gas to be oxidized and reduced under a joint action of the plasma cluster and a catalyst in the catalyst layer, and discharging the waste gas with removed organics through a waste gas outlet.

15. A treatment method using the device for treating the waste gas through the variable-diameter acceleration-based free radical shower in combination with the catalysis according to claim 6, comprising the following steps:
allowing an organic waste gas to enter the background waste gas channel and the electrode waste gas channel through the waste gas inlet;
allowing the organic waste gas in the electrode waste gas channel to be accelerated through the variable-diameter acceleration channel and reach the nozzle electrode; and
forming a free radical shower discharge by a potential difference between the nozzle electrode and the mesh electrode, so that the waste gas ejected from the nozzle electrode is ionized to form a plasma cluster which is mixed with a background gas from the background waste gas channel to form a mixed gas flow, and driving the mixed gas flow to enter the catalyst layer by a gas flow to allow the organic waste gas to be oxidized and reduced under a joint action of the plasma cluster and a catalyst in the catalyst layer, and discharging the waste gas with removed organics through a waste gas outlet.

16. A treatment method using the device for treating the waste gas through the variable-diameter acceleration-based free radical shower in combination with the catalysis according to claim 7, comprising the following steps:
allowing an organic waste gas to enter the background waste gas channel and the electrode waste gas channel through the waste gas inlet;
allowing the organic waste gas in the electrode waste gas channel to be accelerated through the variable-diameter acceleration channel and reach the nozzle electrode; and
forming a free radical shower discharge by a potential difference between the nozzle electrode and the mesh electrode, so that the waste gas ejected from the nozzle electrode is ionized to form a plasma cluster which is mixed with a background gas from the background waste gas channel to form a mixed gas flow, and driving the mixed gas flow to enter the catalyst layer by a gas flow to allow the organic waste gas to be oxidized and reduced under a joint action of the plasma cluster and a catalyst in the catalyst layer, and discharging the waste gas with removed organics through a waste gas outlet.

17. A treatment method using the device for treating the waste gas through the variable-diameter acceleration-based free radical shower in combination with the catalysis according to claim 8, comprising the following steps:
allowing an organic waste gas to enter the background waste gas channel and the electrode waste gas channel through the waste gas inlet;
allowing the organic waste gas in the electrode waste gas channel to be accelerated through the variable-diameter acceleration channel and reach the nozzle electrode; and
forming a free radical shower discharge by a potential difference between the nozzle electrode and the mesh electrode, so that the waste gas ejected from the nozzle electrode is ionized to form a plasma cluster which is mixed with a background gas from the background waste gas channel to form a mixed gas flow, and driving the mixed gas flow to enter the catalyst layer by a gas flow to allow the organic waste gas to be oxidized and reduced under a joint action of the plasma cluster and a catalyst in the catalyst layer, and discharging the waste gas with removed organics through a waste gas outlet.

18. A treatment method using the device for treating the waste gas through the variable-diameter acceleration-based free radical shower in combination with the catalysis according to claim 9, comprising the following steps:
allowing an organic waste gas to enter the background waste gas channel and the electrode waste gas channel through the waste gas inlet;
allowing the organic waste gas in the electrode waste gas channel to be accelerated through the variable-diameter acceleration channel and reach the nozzle electrode; and
forming a free radical shower discharge by a potential difference between the nozzle electrode and the mesh electrode, so that the waste gas ejected from the nozzle electrode is ionized to form a plasma cluster which is mixed with a background gas from the background waste gas channel to form a mixed gas flow, and driving the mixed gas flow to enter the catalyst layer by a gas flow to allow the organic waste gas to be oxidized and reduced under a joint action of the plasma cluster and a catalyst in the catalyst layer, and discharging the waste gas with removed organics through a waste gas outlet.
